(19) United States
(12) Patent Application Publication
(10) Pub. No.: US 2022/0366264 A1
(43) Pub. Date: Nov. 17, 2022

(54) PROCEDURALLY GENERATING REALISTIC INTERFACES USING MACHINE LEARNING TECHNIQUES

(71) Applicant: Klarna Bank AB, Stockholm (SE)

(72) Inventors: Aref Moradi, Stockholm (SE); Alexandra Hotti, Stockholm (SE); Riccardo Sven Risuleo, Stockholm (SE); Stefan Magureanu, Solna (SE)

(21) Appl. No.: 17/318,946

(22) Filed: May 12, 2021

(51) Int. Cl. G06N 3/08; G06N 3/04

(52) U.S. Cl. CPC G06N 3/088; G06N 3/0454; G06N 3/0445

(57) ABSTRACT

Source information for a set of interfaces from a service provider is collected. A generative adversarial network (GAN) is trained using the source information and the set of interfaces. The source information is provided to a generative network of the GAN. The generative network is caused to generate a simulated interface. A discriminative network of the GAN is caused, by providing the simulated interface to the discriminative network, to output an estimate as to the authenticity of the simulated interface. The generative network is trained, based on the estimate, to produce a trained generative network. The trained generative network is caused to generate a plurality of simulated interfaces. A machine learning model is trained, using the plurality of simulated interfaces, to determine how to interact with different types of interfaces.

### CROSS REFERENCE TO RELATED APPLICATION

This application incorporates by reference for all purposes the full disclosure of co-pending U.S. patent application Ser. No. 16/744,017, filed Jan. 15, 2020, entitled “INTERFACE CLASSIFICATION SYSTEM” (Attorney Docket No. 0101560-015US0); U.S. patent application Ser. No. 16/744,021, filed Jan. 15, 2020, entitled “METHOD OF TRAINING A LEARNING SYSTEM TO CLASSIFY INTERFACES” (Attorney Docket No. 0101560-019US0); U.S. Pat. No. 10,846,106, filed Mar. 9, 2020, entitled “REAL-TIME INTERFACE CLASSIFICATION IN AN APPLICATION” (Attorney Docket No. 0101560-016US0); U.S. patent application Ser. No. 17/101,744, filed Nov. 23, 2020, entitled “REAL-TIME INTERFACE CLASSIFICATION IN AN APPLICATION” (Attorney Docket No. 0101560-016US1); U.S. patent application Ser. No. 16/680,392, filed Nov. 11, 2019, entitled “DYNAMIC LOCATION AND EXTRACTION OF A USER INTERFACE ELEMENT STATE IN A USER INTERFACE THAT IS DEPENDENT ON AN EVENT OCCURRENCE IN A DIFFERENT USER INTERFACE” (Attorney Docket No. 0101560-008US0); U.S. patent application Ser. No. 16/680,396, filed Nov. 11, 2019, entitled “UNSUPERVISED LOCATION AND EXTRACTION OF OPTION ELEMENTS IN A USER INTERFACE” (Attorney Docket No. 0101560-009US0); U.S. patent application Ser. No. 16/680,403, filed Nov. 11, 2019, entitled “DYNAMIC IDENTIFICATION OF USER INTERFACE ELEMENTS THROUGH UNSUPERVISED EXPLORATION” (Attorney Docket No. 0101560-010US0); U.S. patent application Ser. No. 16/680,406, filed Nov. 11, 2019, entitled “LOCATION AND EXTRACTION OF ITEM ELEMENTS IN A USER INTERFACE” (Attorney Docket No. 0101560-011US0); U.S. patent application Ser. No. 16/680,408, filed Nov. 11, 2019, entitled “UNSUPERVISED LOCATION AND EXTRACTION OF QUANTITY AND UNIT VALUE ELEMENTS IN A USER INTERFACE” (Attorney Docket No. 0101560-012US0); and U.S. patent application Ser. No. 16/680,410, filed Nov. 11, 2019, entitled “EXTRACTION AND RESTORATION OF OPTION SELECTIONS IN A USER INTERFACE” (Attorney Docket No. 0101560-013U50).

### BACKGROUND

When training a machine learning model, typically a large, representative sample of data needs to be collected for the training set in order to be trained sufficiently to perform accurately. Collecting such a large training set, however, can be very time-consuming in situations where the training set must be downloaded over a network with bandwidth limitations, such as the Internet. Furthermore, accumulating a large representative sample of data can require dedicated computing resources to collect and store the data. Still further, in some situations the amount of data available to be used for the training set is limited, such as in the case where a limited amount of training data exists or access to training data is restricted. When a large, representative sample of data is nonexistent or inaccessible, or if the representative sample of data is limited, the machine learning model may not perform accurately when trained or may perform accurately only under specific conditions.

### BRIEF DESCRIPTION OF THE DRAWINGS

Various techniques will be described with reference to the drawings, in which:

FIG. 1 illustrates an example of an environment for training a machine learning model to recognize interfaces using simulated interfaces in accordance with an embodiment;

FIG. 2 illustrates an example of providing real and simulated interfaces to a discriminator in a generative adversarial network in accordance with an embodiment;

FIG. 3 illustrates an example of training a generator and a discriminator based on guesses by a discriminator in accordance with an embodiment;

FIG. 4 illustrates an example of a type of interface in accordance with an embodiment;

FIG. 5 illustrates an example of another type of interface in accordance with an embodiment;

FIG. 6 is a swim diagram that illustrates an example of training a generative adversarial network to generate realistic simulated interfaces in accordance with an embodiment;

FIG. 7 is a flowchart that illustrates an example of a process of using simulated interfaces to train a machine learning model to recognize and generate integration code for different types of interfaces in accordance with an embodiment; and

FIG. 8 illustrates a computing device that may be used in accordance with at least one embodiment.

### DETAILED DESCRIPTION

Techniques and systems described below relate to techniques for procedural generation of simulated interfaces. In one example, a system obtains a plurality of interfaces from one or more interface providers, and data encoding various components of interfaces, such as interface templates, interface elements, and the like. The system may use the plurality of interfaces and the data to train a generative adversarial network to procedurally generate simulated interfaces. The procedurally generated simulated interfaces may be used subsequently to train machine learning models; for example, a reinforcement learning agent may be trained, based on the procedurally generated simulated interfaces, to generate executable software code that, when executed by a device, enables the device to perform a set of tasks, such as classifying and interacting with different types of interfaces. For example, the reinforcement learning agent may be trained to generate executable software code, that when executed by a computing device, causes the computing device to simulate human interaction with an interface (e.g., using click events and text input to interact with form elements on the interface). In some examples, procedural generation refers to methods of generating data algorithmically with minimal manual intervention.

In various examples, the generative adversarial network includes a generator network and a discriminator network. The generator network may generate simulated interfaces based on the data encoding various components of interfaces, and the discriminator network may predict whether a given interface is a simulated interface or a real interface of the plurality of interfaces; the generator network may be trained to generate simulated interfaces that approximate real interfaces, and the discriminator network may be trained to distinguish between simulated interfaces and real interfaces. The trained generative network may then generate simulated interfaces, which can be utilized by the system as data in a training environment for the machine learning model.

The system may use the simulated interfaces to train the machine learning model (e.g., a reinforcement learning agent) on how to navigate an interface in order to complete a task. Such training may include training the machine learning model to distinguish between different categories of interfaces and identify the various elements of the interfaces. The simulated interfaces may be used as a training framework for the machine learning model to learn to perform various processes in connection with the interfaces and elements of the interfaces. In some examples, the reinforcement learning agent is trained using reinforcement learning processes in connection with the simulated interfaces. In some embodiments, the reinforcement learning agent may be trained to generate integration code, which may be computer-executable code that, when executed, can cause a device to process interfaces and perform various operations with the interfaces, such as classifying the interfaces, classifying and determining functionalities of elements of the interfaces, simulating human interaction in connection with the elements of the interfaces to perform various processes, and the like.

The system may receive, from a client device of a user, a request for integration code. The client device may access an interface provided by an interface provider. A user of the client device may seek to perform various operations with the interface. The user may submit the request through the client device, in which the system may generate, based on the machine learning model, the integration code. In various examples, the integration code is executable code generated by the machine learning model to cause a device to determine the type or classification of a given interface, and/or perform various processes using elements of the given interface. The system may provide the client device with the integration code.

The system may cause, by providing the integration code to the client device, the client device to determine the category of the interface and interact with the interface in a manner that accords with the interface category. The client device, upon execution of the integration code in connection with the interface, may perform the various operations with the interface. The client device may execute the integration code to determine the type of the interface. The client device may perform various processes that may be specific to the category of the interface in connection with elements of the interface.

In an illustrative example of a use case that uses the techniques described in the present disclosure, an interface provider of the above mentioned interface providers may be a library entity of many library entities that utilize one or more interfaces that users may interact with to access the services of the library entity. A system of the present disclosure may obtain interfaces provided by the library entity, as well as components of various interfaces of other interface and service providers, to train a generator network and a discriminator network of a generative adversarial network, in which the trained generator network may generate simulated interfaces. The system may train a machine learning model using the generated simulated interfaces such that the machine learning model can generate executable code usable by a computing device to identify types or categories of interfaces of the library as well as interact with elements of the library's interfaces. A user of the library entity may utilize an interface provided by the library entity. The user may seek to determine the type of the interface and perform an action in connection with the interface (e.g., select a book depicted in the interface). The user may submit a request for integration code encoding at least the action to the system, in which the system may generate the integration code based on parameters of the request. The integration code may be executable code that may determine the type of the interface and perform the action in connection with the interface. The user may execute the integration code in connection with the interface to determine the type of the interface and perform the action in connection with the interface.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be left out or simplified to avoid obscuring the techniques being described.

Techniques described and suggested in the present disclosure improve the field of computing, particularly the field of software development, by generating training data for software agents, machine learning models, and other software or hardware tools to determine how to identify types of interfaces and determine how to interact with the interfaces. Additionally, techniques described and suggested in the present disclosure improve, using machine learning models and models as described in the present disclosure, the speed and accuracy of training systems to navigate interfaces by generating simulated interfaces for offline or local network use. Moreover, techniques described and suggested in the present disclosure are necessarily rooted in computer technology in order to overcome problems with training machine learning models specifically arising due to slow/limited bandwidth of network connections in obtaining machine learning training data, limited availability of machine learning training data, or limited access to machine learning training data.

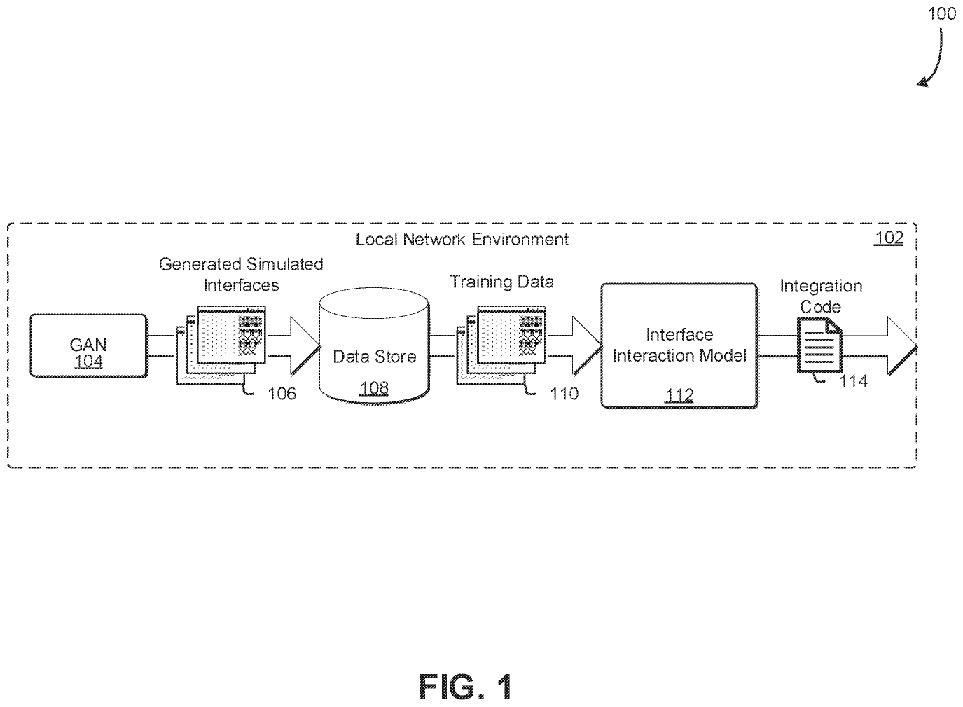

FIG. 1 illustrates an example 100 of an environment for training a machine learning model using simulated interfaces, in accordance with an embodiment. In an embodiment, as illustrated in FIG. 1, the example 100 includes a local network environment 102 comprising a generative adversarial network 104 that generates simulated interfaces 106, which are stored in a data store 108 and utilized as training data 110 for an interface interaction model 112 to determine integration code 114.

The local network environment 102 may be any suitable computing environment. The local network environment 102 may be a computing environment comprising various software and/or hardware computing resources that communicate through one or more local networks, such as a local area network, and may access one or more global networks, such as the Internet. The local network environment 102 may be implemented on one or more computer servers using one or more private networks. The local network environment 102 may comprise various computing devices. Examples of such a computing device include one or more instances of a physical computing instance (e.g., a physical server computer, a mobile communication device, a laptop computer, a tablet computer, a personal computer, a mainframe, etc.), one or more instances of a virtual computing instance, such as a virtual machine hosted on one or more computer servers, and/or other computing systems capable of communicating with various systems and/or services.

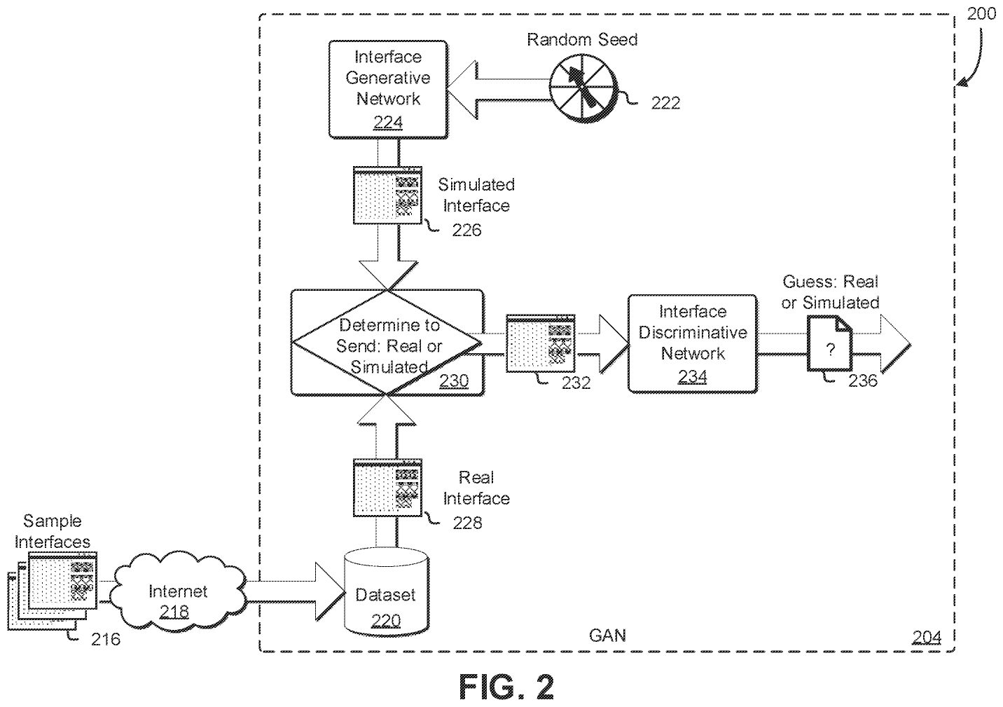

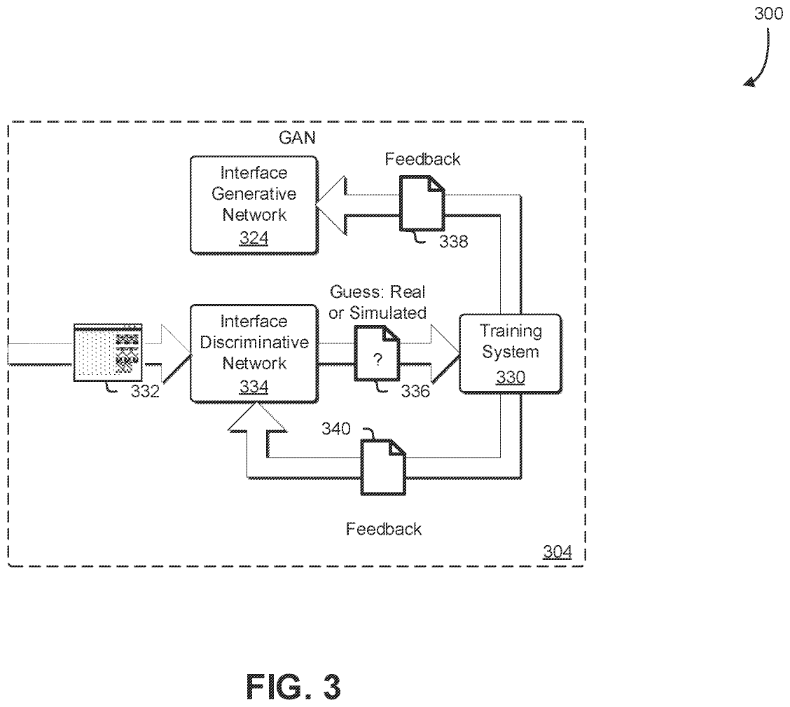

The generative adversarial network 104 may refer to one or more machine learning frameworks that comprise at least two neural networks, which may be referred to as a generator neural network and a discriminator neural network. The generative adversarial network 104 may be implemented as a collection of one or more software and/or hardware computing resources with instructions that, when executed, cause the computing resources to perform one or more machine learning operations. The generative adversarial network 104 may generate the generated simulated interfaces 106. The generative adversarial network 104 may obtain or otherwise receive a random seed for a pseudorandom number generator and a set of real interfaces, in which a generative network of the generative adversarial network 104 may generate simulated interfaces based on the random seed and the set of real interfaces, and a discriminative network of the generative adversarial network 104 may predict whether a given interface is a simulated interface or a real interface; the generative network may be trained to generate simulated interfaces that approximate real interfaces, and the discriminative network may be trained to distinguish between simulated interfaces and real interfaces. The trained generative network may then generate simulated interfaces 106. Further information regarding a generative adversarial network can be found in the descriptions of FIGS. 2 and 3.

An interface may be any suitable interface that may be provided by an interface provider, service provider, and/or variations thereof. Examples of such services an interface may be associated with include data processing, data storage, software applications, library services, utility services, television services, entertainment services, and/or other such services. An interface may be a web page of various types, such as home pages, item pages, collection pages, queue pages, search pages, profile pages, media player pages, news feed pages, blog pages, and so on. An interface may be any suitable markup language interface, such as a HyperText Markup Language (HTML) interface and variations. An interface may include various interface elements that provide various functionality, such as enabling a user to input or obtain data, enabling a user to modify aspects of the interface, enabling a user to open one or more other interfaces, and the like. An interface may be represented by an object model that may be structured in a hierarchical format, in which elements/objects of the interface may be identified according to various attributes, functions, namespaces, values, and/or variations thereof. An interface may be any suitable interface, such as a graphical user interface or other interface, provided by a service to a user for interaction.

The simulated interfaces 106 may be interfaces generated or otherwise simulated by the generative adversarial network 104 once it has been trained according to the process illustrated in FIGS. 2, 3, 6, and 7. The generative adversarial network 104 may be trained to simulate and generate interfaces. The simulated interfaces 106 may comprise interfaces of various types.

Examples of the simulated interfaces 106 include web pages, graphical user interfaces for a mobile device, or other such types of user interfaces. The simulated interfaces 106 may comprise interfaces that may or may not be associated with existing interface providers, service providers, and/or variations thereof. The simulated interfaces 106 may comprise interfaces with various interface elements that may provide a range of functionality. In some examples, the simulated interfaces 106 comprise interfaces with interface elements that enable entities to input data, obtain data, modify interfaces, open other interfaces, and/or variations thereof.

The simulated interfaces 106 (which may also referred to as imitation interfaces) may comprise a set of interfaces that may collectively form or otherwise represent a Web domain, in which elements of the set of interfaces may enable interaction between interfaces of the set of interfaces. For example, the simulated interfaces 106 may comprise functional relationships, such as links (e.g., hyperlinks) that connect different interfaces of the simulated interfaces 106 to produce a simulated Web domain. In an embodiment, the simulated interfaces 106 are not replicas of actual interfaces, but are interfaces that comprise sufficient components to cause the interfaces to approximate actual interfaces such that a machine learning model (e.g., the interface interaction model 112) can be trained with sufficient accuracy on how to identify characteristics of an interface and how to interact with the interface, such as determining how to classify an interface and/or generate the integration code 114 usable to cause another computing device to interact with such interfaces. A real or actual interface may refer to an existing interface of an existing interface provider or service provider (e.g., an existing web page of an Internet Web domain). In some examples, a “Web domain” refers to a collection of web pages and related content that is identified by a common Internet domain name and published on at least one web server. In the present disclosure, a “real interface” may refer to an interface not generated by the generative adversarial network 104, such as a web page provided by a service provider for use by users of a service provided by the service provider. The simulated interfaces 106 may be output to the data store 108.

The data store 108 may be any device or combination of devices capable of storing, accessing, and retrieving data. The data store 108 may include any combination and number of data servers, databases, data storage devices, and data storage media, and in any standard, distributed, virtual, or clustered system. The data store 108 may communicate with block-level and/or object level interfaces. The data store 108 may include several separate data tables, databases, documents, dynamic data storage schemes, and/or other data storage mechanisms and media for storing data relating to a particular aspect of the present disclosure.

In some examples, the data store 108 is an on-demand data store that may be managed by an on-demand data storage service. An on-demand data storage service may be a collection of computing resources configured to synchronously process requests to store and/or access data. The on-demand data storage service may allow data to be provided in response to requests for the data and may operate using computing resources (e.g., databases) that enable the on-demand data storage service to locate and retrieve data quickly. For example, the on-demand data storage service may maintain data stored in various on-demand data stores in a manner such that, when a request for a data object is retrieved, the data object can be provided (or streaming of the data object can be initiated) in a response to the request. The data store 108 may be utilized to store the simulated interfaces 106 and other data that may collectively form the training data 110.

The training data 110 may be a collection of data used in a training environment to train the interface interaction model 112 how to identify different types of interfaces and how such interfaces can be interacted with. For example, the training data 110 may be used in a training environment for training a reinforcement learning agent to classify interfaces and/or classify and identify elements of the interfaces, and perform actions in connection with the interfaces and/or the elements of the interfaces. In some examples, the “environment” of the training environment comprises a Web domain with one or more simulated interfaces, which include structure, state, behavior, and functionality of the one or more simulated interfaces. In some examples, such structure may include a document object model (DOM) of an interface. In some examples, state of an interface may include information tracking current dynamic changes that were made to the DOM due to simulated or real interactions with the interface (e.g., selecting options from a dropdown element, entering text into a form element, etc.) or due to information associated with a particular session (e.g., date/time, user identity, etc.). In some examples, interface “behavior” refers to actions performed in response to the simulated or real interactions with the interface (e.g., changing a state of a DOM element, navigating to another interface, uploading or downloading information, etc.). In some examples, “functionality” refers to the function performed via an element in the interface (e.g., an element for selecting options, an element for submitting selections, an element for navigating to another interface, etc.).

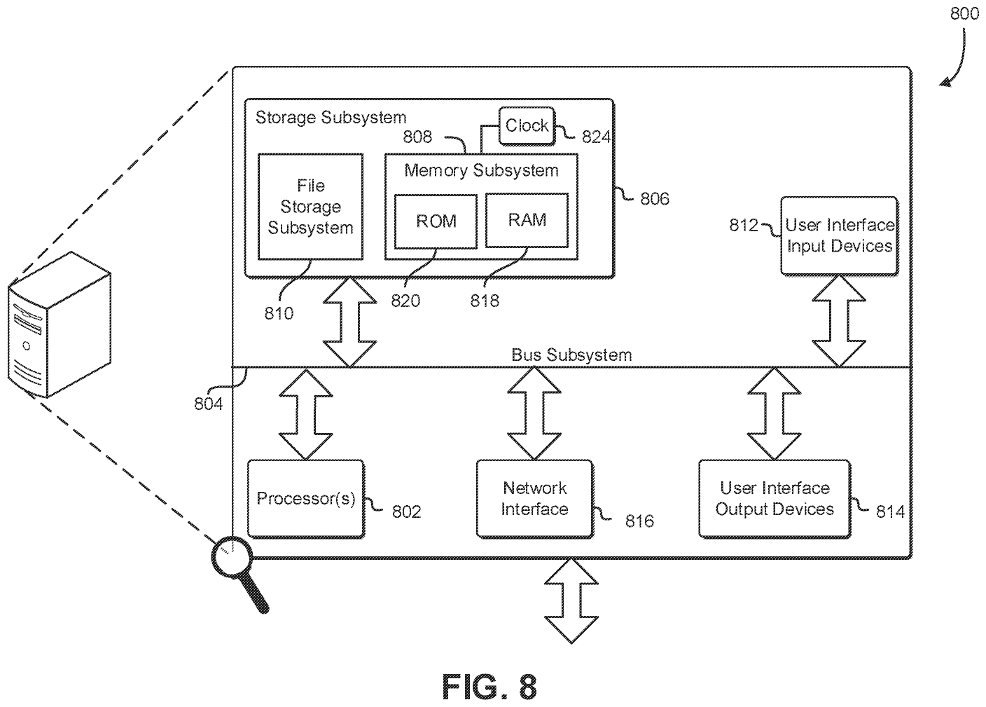

The training data 110 may comprise the simulated interfaces 106. The training data 110 may comprise one or more real interfaces of existing service providers and/or interface providers. The training data 110 may be utilized to train the interface interaction model 112. The interface interaction model 112 may be a collection of machine learning models and/or models trained to generate integration code that, if executed, may cause a computing device to interact with interfaces. For example, the integration code may cause a client device to classify interfaces and/or elements of interfaces, and simulate human interaction in connection with the interfaces and/or the elements. The interface interaction model 112 may be implemented as software, hardware, and/or variations thereof. The interface interaction model 112 may comprise one or more neural networks and/or machine learning models that may be configured to generate executable code that, when executed, identifies various interfaces and/or elements within the various interfaces, and interacts with the various interfaces. In some examples, the interface interaction model 112 may be implemented as a software application or service executing on a computing device, such as the computing device 800 of FIG. 8.

In some examples, the interface interaction model 112 may be a reinforcement learning model that has been trained to determine a classification, also referred to as a category or type, of a given interface and/or elements of the given interface. A classification of an interface and/or element may indicate the functionality, one or more characteristics, one or more use cases, and/or variations thereof, of the interface and/or the element. The interface interaction model 112 may be a machine learning model such as described in U.S. patent application Ser. No. 16/744,017, Ser. No. 16/744,021, and/or Ser. No. 17/101,744, incorporated by reference above.

The interface interaction model 112 may be further trained by simulated human interaction with different interfaces (such as in the training data 110 derived from the generated simulated interfaces 106), such as performing various sequences of actions in connection with elements of the different interfaces described in U.S. patent application Ser. No. 16/680,392, Ser. No. 16/680,396, Ser. No. 16/680,403, Ser. No. 16/680,406, Ser. No. 16/680,408, and/or Ser. No. 16/680,410, incorporated by reference above. The interface interaction model 112 may be trained using a dynamic process that involves performing one or more tasks comprising sequences of actions with one or more interfaces. For example, a sequence of actions can include selecting (e.g., by simulating human interaction with an interface) a first element of the interface, selecting a second element of the interface, and inputting data into the second element of the interface. The interface interaction model 112 may be trained by computer execution of a dynamic process that analyzes source code of interfaces and performs actions to the interfaces that the computer execution detects are supported by the interfaces, such as selecting elements of the interfaces, inputting data to elements of the interfaces, extracting data from elements of the interfaces, and the like. The interface interaction model 112 may be trained such that, for a given interface page, the interface interaction model 112 may generate the integration code 114 that may, when executed by a computing device, cause the computing device to classify the interface and/or elements of the interface, and perform one or more actions in connection with the interface and/or the elements of the interface. The interface interaction model 112 may be trained through one or more reinforcement learning processes, or any suitable machine learning training process, such as supervised and/or unsupervised learning processes.

Reinforcement learning may refer to one or more machine learning processes that train an agent (e.g., the interface interaction model 112) to perform various tasks by associating rewards/penalties with various outcomes of the actions of the agent. The agent may be trained through one or more reinforcement learning processes through the use of rewards/penalties. The rewards/penalties may be implemented by increasing or decreasing weight values associated with characteristics of the interface. An agent, also referred to as an intelligent agent or more generally as a machine learning model, may be an entity implemented using one or more hardware and/or software computing resources that autonomously acts to perform one or more tasks. In some examples, an agent is trained to classify interfaces, in which the agent is rewarded when the agent accurately classifies interfaces, and penalized or unrewarded when the agent does not accurately classify interfaces. For example, increasing weight values associated with components of successfully classified interfaces may cause the agent to give more weight to those components. In another example, an agent is trained to perform a particular task, in which the agent is rewarded positively when the task is completed successfully, and penalized or unrewarded when the agent is unable to complete the task. For example, reducing weight values associated with components of unsuccessfully classified interfaces may cause the agent to give less weight to those components. The interface interaction model 112 may utilize reinforcement learning in order to determine how to generate integration code that, if executed by a device, can cause the device to perform one or more actions appropriate to a particular type of interface.

In some examples, the agent may extract a set of properties/characteristics from a DOM of an interface whose interface type/category is known. The set of properties/characteristics may be in the form of sets of name/value pairs (also known as attribute value pairs, key-value pairs, or field-value pairs). Thus, each of the sets of properties/characteristics along with its corresponding interface type/category as a ground truth value may comprise training data for the machine learning model to be trained to classify interfaces. The more interfaces that can be processed into training data in this manner, the more accurately the machine learning model may be trained to classify interfaces. Further details of training such machine learning models may be found in U.S. patent application Ser. No. 16/744,017, Ser. No. 16/744,021, and/or Ser. No. 17/101,744, incorporated by reference above.

The integration code 114 may be a script encoding a set of instructions, annotations, and/or attributes using a combination of one or more computer languages such as JavaScript, and/or variations thereof. The integration code 114 may be executable software code that, when executed by one or more devices, simulates human interaction with a different interface in a same category of interfaces as interfaces of the training data 110. As one example, integration code 114 may be a script that, when executed by a device, causes the device to classify an interface and/or identify elements of the interface. The integration code 114 may be a script that, when executed, performs one or more tasks or actions utilizing (such as by simulating human interaction with) elements of an interface. The integration code 114 may encode one or more sequences of actions that perform various functionality in connection with an interface and elements of the interface. Examples and further details about generating and utilizing the integration code 114 may be found in U.S. patent application Ser. No. 16/744,017, Ser. No. 16/744,021, Ser. No. 17/101,744, Ser. No. 16/680,392, Ser. No. 16/680,396, Ser. No. 16/680,403, Ser. No. 16/680,406, Ser. No. 16/680,408, and/or Ser. No. 16/680,410, incorporated by reference above.

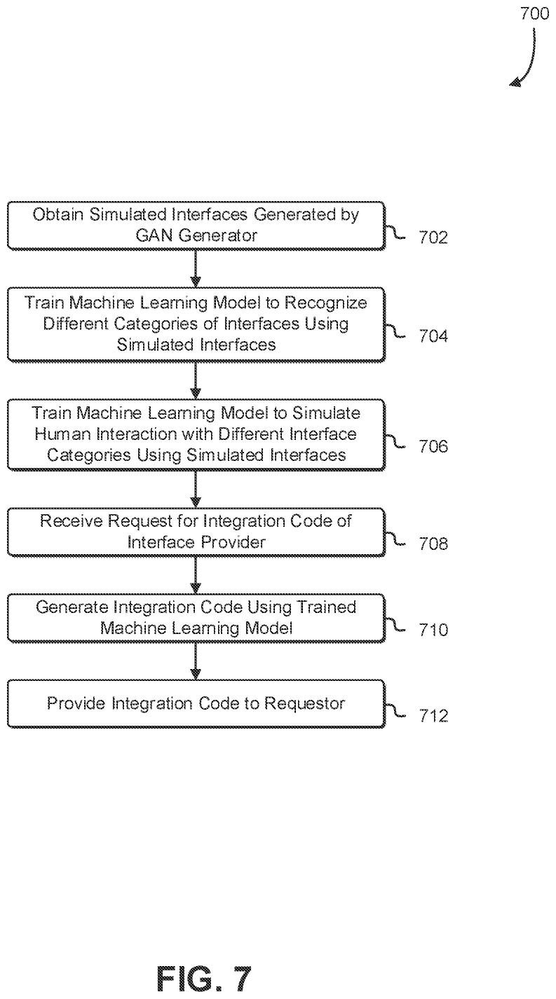

In some implementations, the integration code 114 may be executed by a particular software application running on a client device. As used in the present disclosure, “integration code” may refer to executable scripts that may, if executed, cause a device to perform various actions in connection with given interfaces. In an example, a user may have a client device installed with a software application provided by a service provider. The software application may be a software agent designed to dynamically cause the client device to perform sets of tasks (e.g., browsing, selecting interface objects, following hyperlinks, submitting forms, etc.) as an agent for (e.g., authorized to act on the behalf of) the user. However, all interfaces are not the same; different interfaces from different interface providers may have different functionalities, purposes, and components, and the integration code 114 may provide specific instructions to the software application on how to determine which category/type of interface is being interacted with and how to interact with (e.g., simulating human interaction with interface components, making application programming interface calls, etc.) the particular interface or interface category. Thus, for an interface comprising a set of elements, the integration code 114, when executed by a client device, may cause the client to perform one or more tasks via the interface; for example, the integration code 114 may cause the client device to classify the interface based on the set of the elements, input data into one or more elements of the elements, select one or more options available to a form element (e.g., checkbox, dropdown, radio button, etc.), and/or select one or more elements in the interface to cause the data to be processed by the interface provider. Further information regarding the interface interaction model 112 and the integration code can be found in the description of FIG. 7.

FIG. 2 illustrates an example 200 of providing real and simulated interfaces to a discriminator in a generative adversarial network, in accordance with an embodiment. In an embodiment, the example 200 includes a generative adversarial network 204 that comprises an interface generative network 224 and an interface discriminative network 234. The generative adversarial network 204 may obtain sample interfaces 216 from an Internet 218 and store the sample interfaces 216 in a dataset 220. The interface generative network 224 may generate a simulated interface 226 based on a random seed 222. The dataset 220 may provide a real interface 228 to a training system 230, which may provide a test interface 232 based on the real interface 228 or the simulated interface 226 to the interface discriminative network 234, which may determine a guess 236. The generative adversarial network 204 may be in accordance with those described in connection with FIG. 1.

The generative adversarial network 204 may be a machine learning framework for generating new data based on characteristics of training data. The generative adversarial network 204 may be similar to the generative adversarial network 104 of FIG. 1. The generative adversarial network 204 may be implemented as a collection of one or more software and/or hardware computing resources with instructions that, when executed by a device, causes the device to perform one or more machine learning operations. The generative adversarial network 204 may be a software application, software program, and the like, which may be operating on one or more physical and/or virtual computing instances. The generative adversarial network 204 may obtain or otherwise receive the sample interfaces 216 via the Internet 218.

The sample interfaces 216 may be any suitable interfaces that may be made available by an interface provider, service provider, and/or variations thereof for use by its users. Examples of such services an interface may be associated with include data processing, data storage, software applications, security, encryption, library services, utility services, television services, entertainment services and/or other such services. The sample interfaces 216 may be web pages of various types, such as home pages, item pages, collection pages, queue pages, search pages, profile pages, media player pages, news feed pages, blog pages, and so on. The sample interfaces 216 may include web pages from sites corresponding to one or more service providers. The sample interfaces 216 may include various interface elements that provide various functionality, such as enabling a user to input or obtain data, enabling a user to modify aspects of the interface, enabling a user to open one or more other interfaces, and the like.

The sample interfaces 216 may be real interfaces of existing service providers, interface providers, and/or variations thereof. The sample interfaces 216 may be obtained from one or more web servers accessible via the Internet 218. The sample interfaces 216 may be obtained in the form of source code; interface source code may be written as a set of instructions, annotations, and attributes using a combination of one or more computer languages, such as JavaScript, HTML, Extensible Markup Language (XML), C#, Visual Basic, Cascading Style Sheets (CSS), Java, Perl, Hypertext Preprocessor (PHP), Python, Ruby, or other computer language. In some embodiments, source code may be represented as a hierarchical tree structure (e.g., an object model) comprised of components and their properties (collectively referred to as “elements” or “nodes”) descending from a base (“root”) object or node. The source code may further include other companion resources, such as images, animations, applets, audio files, video files, or other such resources linked to (e.g., via hyperlinks) in the source code. The Internet 218 may refer to one or more global computer networks that use the Internet protocol suite to communicate between networks and devices. The generative adversarial network 204 may obtain the sample interfaces 216 from the Internet 218 and store the sample interfaces 216 in the dataset 220.

The dataset 220 may be a set of data stored in one or more data stores. The dataset 220 may comprise a set of sample web pages (e.g., the sample interfaces 216). In some examples, the dataset 220 comprises web pages in a Multipurpose Internet Mail Extensions (MIME) encapsulation of aggregate HTML documents (MHTML) format. The dataset 220 may comprise the sample interfaces 216 in various formats, including source code of the sample interfaces 216. The dataset 220 may include the real interface 228, which may be an interface of the sample interfaces 216.

The random seed 222 may be a number or vector used to initialize a pseudorandom number generator of the interface generative network 224. In embodiments, the random seed 222 may be a different number each time so that the pseudorandom number generator does not output the same sequence of “random” numbers every time it is initialized, but the random seed 222 itself need not necessarily be random since the values generated by the pseudorandom number generator will follow probability distribution in a pseudorandom manner. In embodiments, the random seed 222 may be associated with a time/date value based on a current state of a computer system clock, generated by a cryptographically secure pseudorandom number generator, or generated by a hardware random number generator. The random seed 222 may be used to ensure that the simulated interface 226 is generated by the interface generative network with a level of unpredictability (e.g., different controls, different images, different functionality assigned to interface elements, and/or locations of objects in the interface from previously generated interfaces).

The interface generative network 224 may be one or more neural network models of the generative adversarial network 204. The interface generative network 224 may include one or more generative models, such as a Gaussian mixture model, Hidden Markov model, probabilistic context-free grammar model, Bayesian network model, averaged one-dependence estimators model, Latent Dirichlet allocation model, Boltzmann machine model, variational autoencoder model, energy based model, and/or variations thereof. The interface generative network 224 may be a tree long short-term memory (LSTM) neural network, which may refer to a neural network that is a generalization of LSTM networks to tree-structured network topologies. In an embodiment, the interface generative network 224 is implemented through one or more data structures, such as one or more arrays, lists, and/or trees, that encode weights, biases, and structural connections (e.g., architecture(s) and/or configuration(s) of one or more neurons) of the interface generative network 224. A common internal representation of neural network structures in computers is a graph where nodes represent data (in the form of arrays in memory) and operations and the edges connect operations, operands, and outputs.

The interface generative network 224 may be a neural network that is configured to generate new data from input data. The input data may be a source code and companion resources for a set of real interfaces which have been transformed into a DOM tree and converted into data suitable for inputting into the interface generative network 224. The interface generative network 224 may generate the simulated interface 226 based on the random seed 222 and the sample interfaces 216. The interface generative network 224 may assign weights to various interface components based on the sample interfaces 216 and/or other factors, and the weights may influence the number, type, and placements of such interface components in the simulated interface 226. Based on feedback, such as the feedback 338 of FIG. 3, the interface generative network 224 may retrain itself by modifying the weights in an attempt to generate more realistic simulated interfaces. In one embodiment, the system pseudorandomly generates a set of components (e.g., a pseudorandom number of components) and pseudorandomly assigns connections between the components to create a hierarchy that mimics a DOM tree. In another embodiment, the system starts from a root node (e.g., an empty document or document template) and stepwise chooses a decision pseudorandomly from a set of available options (e.g., add a particular component, branch a new child, stop, etc.). In both embodiments, the weights may reflect (e.g., implicitly through neural network architecture) the probabilities of each possible action (e.g., how many nodes to create, how probable branching is at each step, etc.).

The interface generative network 224 may generate the simulated interface 226 by taking, as input, a random vector of numbers (e.g., the random seed 222) and pseudorandomly combining one or more components (e.g., images, buttons, hyperlinks, text, animations, applets, backgrounds, etc.) of the sample interfaces 216 and producing, as output, the simulated interface 226 (or generating one or more components having similarities to one or more components of the sample interfaces 216). The interface generative network 224 may further determine to pseudorandomly incorporate new styles for the simulated interface 226, such as changing the placement of one or more components of the simulated interface 226, changing the color of one or more components of the simulated interface 226, introducing new values in the CSS of the simulated interface 226, and so on.

The interface generative network 224 may generate the simulated interface 226 based on one or more templates that specify certain constraints or guidelines for generating interfaces of certain categories. For example, the dataset 220 may include one or more interface templates for different types of interfaces. In some examples, a “template” in the present disclosure refers to a set of static interface elements that provide a basic structure and appearance for the interface. The interface generative network 224, in generating the sample interface 216, may begin with a particular template and then may, in accordance with a pseudorandom number generator and/or various weights, dynamically add elements, remove elements, or modify properties of elements to produce the simulated interface 226.

The simulated interface 226 may be an interface of any suitable type of interface in accordance with the sample interfaces 216 in the dataset 227. In some examples, the simulated interface 226 may be generated to be associated with existing interface providers or service providers, whereas in other examples, the simulated interface 226 may correspond to a non-existent (e.g., fictional) interface provider or service provider, and in still other examples, the simulated interface 226 may be generated to be a combination of real and fictitious interface providers or service providers. The simulated interface 226 may comprise various interface elements that may provide various functionality such as interface elements (e.g., images, buttons, checkboxes, text boxes, drop down elements, list boxes, etc.) that enable entities to input data, obtain data, modify interfaces, open other interfaces, and/or variations thereof. The simulated interface 226 may be formatted as an HTML document, MHTML document, or any suitable interface encoding. The simulated interface 226 may be generated in an attempt to appear to look like a real interface (e.g., as a structure of a DOM tree with some web/HTML features attached to each node).

The real interface 228 may be an interface of the dataset 220. The real interface 228 may be associated with existing interface providers, service providers, and/or variations thereof. The real interface 228 may comprise various interface elements that may provide various functionality such as interface elements that enable entities to input data, obtain data, modify interfaces, open other interfaces, and/or variations thereof. The real interface 228 may be formatted as an HTML document, MHTML document, or any suitable interface encoding. The simulated interface 226 and the real interface 228 may be obtained or otherwise received by the training system 230. Note that the simulated interface 226 and the real interface 228, although referred to herein in the singular for illustrative purposes, could include a collection of interfaces and related content (e.g., images, scripts, styles, etc.) that comprise an interrelated hierarchy of interfaces or Web domain.

The training system 230 may be a collection of one or more software and/or hardware computing resources with instructions that, when executed by a device, causes the device to perform one or more neural network training operations. The training system 230 may be a software application, software program, and the like, which may be operating on one or more physical and/or virtual computing instances. The training system 230 may implement one or more processes of one or more training frameworks, such as a PyTorch, TensorFlow, Boost, Caffe, Microsoft Cognitive Toolkit/CNTK, MXNet, Chainer, Keras, Deeplearning4j, or other training framework. The training system 230 may determine to send either a real interface (e.g., the real interface 228) or a simulated interface (e.g., the simulated interface 226).

The training system 230 may comprise logic for determining whether a real interface or a simulated interface is to be sent to the discriminative network 234. The logic may encode various rules for selecting a real interface or simulated interface to send. The logic may indicate a pattern or sequence of real interfaces and/or simulated interfaces to send (e.g., first send a real interface, second send a simulated interface, and so on). The training system 230 may determine whether to send a real interface or a simulated interface pseudorandomly using one or more pseudorandom number generators, in which values output by the one or more pseudorandom number generators determine whether a real interface or a simulated interface is sent (e.g., the one or more pseudorandom number generators may output a first value indicating that a real interface is to be sent, or a different second value indicating that a simulated interface is to be sent). The training system 230 may determine whether to send a real interface or a simulated interface based on loss calculations of the generative adversarial network 204. The training system 230 may determine to send either a real interface or a simulated interface using any suitable processes, functions, logic, rules, and the like. If the training system 230 determines to send a real interface, the real interface may be selected pseudorandomly, or according to some other selection method, from the dataset 220.

The training system 230 may send the test interface 232 comprising either a real interface (e.g., the real interface 228) or a simulated interface (e.g., the simulated interface 226) to the interface discriminative network 234. The test interface 232 may be either the real interface 228 or the simulated interface 226, which may be determined by the training system 230. In either case, the test interface 232 may be similar in structure; for example, both the real interface 228 and the simulated interface 226 may have a structure of a DOM tree with web or HTML features attached to the nodes. The test interface 232 may be provided to or otherwise received by the interface discriminative network 234. The interface discriminative network 234, also referred to as a discriminator, may be one or more neural network models of the generative adversarial network 204.

The interface discriminative network 234 may include one or more discriminative models, such as a k-nearest neighbors algorithm model, logistic regression model, Support Vector Machines (SVM) model, Decision Trees model, Random Forest model, Maximum-entropy Markov model, conditional random fields (CRF) model, and/or variations thereof. The interface discriminative network 234 may be a graph convolutional network (GCN), which may refer to a type of convolutional neural network that processes graphs and associated structural information of the graphs. In an embodiment, the interface discriminative network 234 is implemented through one or more data structures, such as one or more arrays, lists, and/or trees, that encode weights, biases, and structural connections (e.g., architecture(s) and/or configuration(s) of one or more neurons) of the interface discriminative network 234. The interface discriminative network 234 may determine whether an input interface is a real interface or a simulated interface.

The interface discriminative network 234 may determine whether the test interface 232 is the simulated interface 226 or the real interface 228. The interface discriminative network 234 may take, as input, the test interface 232 (which may be either the real interface 228 or the simulated interface 226) through one or more functions to determine what the test interface 232 corresponds to. The interface discriminative network 234 may output the guess 236, which may indicate a determination by the interface discriminative network 234 of what the test interface 232 corresponds to. The guess 236 may be data that indicates a classification of the test interface 232 (e.g., whether it is a simulated interface or a real interface). The guess 236 may be a binary value, in which a first value indicates that the test interface 232 is a simulated interface and a second value indicates that the test interface 232 is a real interface. The guess 236 may be a vector comprising a first value and a second value, in which the first value indicates a probability that the test interface 232 is a simulated interface and the second value indicates a probability that the test interface 232 is a real interface. The guess 236 may be output to a training system, as described in further detail in connection with FIG. 3.

In some embodiments, interface discriminative network 234 has full access to the test interface 232 and can and obtain whatever representation is best suited for its operation. For example, the interface discriminative network 234 may have access to the original HTML, JavaScript, and CSS code that generated the test interface 232, or to a rendered version of the test interface 232 in an appropriate browser. Alternatively, the interface discriminative network 234, may have access to features derived deterministically from the test interface 323, such as the text, the HTML tags, the names and attributes of DOM nodes, the images, counts of different types of element (e.g., number of fields, number of images, number of n-grams, etc.), and the like.

FIG. 3 illustrates an example 300 of training a generator and a discriminator based on guesses by a discriminator, in accordance with an embodiment. In an embodiment FIG. 3 illustrates a continuation of one or more processes as described in connection with FIG. 2. A generative adversarial network 304, a training system 330, a test interface 332, an interface discriminative network 334, a guess 336, and an interface generative network 324 may be in accordance with the generative adversarial network 204, the training system 230, the test interface 232, the interface discriminative network 234, the guess 236, and the interface generative network 224, respectively, as described in connection with FIG. 2. The training system 330 may provide feedback 338 and feedback 340 based at least in part on the guess 336. The generative adversarial network 304 may be similar to the generative adversarial networks 104 and 204 of FIGS. 1 and 2.

The test interface 332 may be determined by the training system 330 as part of one or more processes as described in connection with the training system 230 of FIG. 2. The test interface 332 may be similar to the test interface 232 of FIG. 2. The training system 330 may be a collection of one or more software and/or hardware computing resources with instructions that, when executed by a device, causes the device to perform one or more neural network training operations. The training system 330 may determine to send the test interface 332 comprising either a real interface or a simulated interface. The test interface 332 may be sent to the interface discriminative network 334 by the training system 330. The test interface 332 may comprise either a real interface or a simulated interface generated by the interface generative network 324. The interface generative network 324 may be one or more neural network models of the generative adversarial network 304. The interface generative network 324 may be a neural network that is configured to generate new data from input data. The interface generative network 324 may generate the simulated interface based on a random seed and at least one real interface.

The test interface 332 may be provided to or otherwise received by the interface discriminative network 334. The interface discriminative network 334 may be one or more neural network models of the generative adversarial network 304. The interface discriminative network 334 may be a neural network that is configured to classify data. The interface discriminative network 334 may determine whether an input interface is a real interface or a simulated interface as described above in conjunction with FIG. 2.

The interface discriminative network 334 may receive the test interface 332 as a set of inputs and process the set of inputs through one or more functions to attempt to determine what the test interface 332 corresponds to (e.g., whether the test interface 332 is a real interface or a simulated interface). The interface discriminative network may be similar to the interface discriminative network 234 of FIG. 2. The interface discriminative network 334 may output the guess 336, which may indicate a determination by the interface discriminative network 334 of a predicted classification of the test interface 332.

The guess 336 may be data that indicates a classification of the test interface 332 (e.g., whether it is a simulated interface or a real interface). The guess 336 may be similar to the guess 236 of FIG. 82. The guess 336 may be a measure or estimate as to the authenticity of the test interface 332, in which an authentic interface may refer to a real interface, and an inauthentic interface may refer to a simulated interface. The guess 336 may be a binary value, a vector of values, or any suitable representation that indicates a prediction of a classification of the test interface 332. The guess 336 may be output to the training system 330.

The training system 330 may determine if the guess 336 is correct. In various embodiments, the training system 330 determines the test interface 332 and stores one or more indications of what the test interface 332 is (e.g., a simulated interface or a real interface). The training system 330 may compare a stored indication of a classification of the test interface 332 with the guess 336. The training system 330 may provide the feedback 338 to the interface generative network 324 based on the guess 336. The training system may provide the feedback 340 to the interface discriminative network 334 based on the guess 336.

For every simulated interface (such as the simulated interface 226 of FIG. 2) output by the interface generative network 324, the interface generative network receives feedback, such as the feedback 338, whether the discriminative network 334 thought the simulated interface was real or not. In this way, the interface generative network 324 adapts itself to produce simulated data that looks real, and the interface discriminative network 334 likewise adapts itself using the feedback 340 to get better at discerning differences between real and simulated data, which causes the interface generative network 324 to further improve. The feedback 338 may be a collection of data determined by the training system 330 based on the guess 336. The feedback 338 may comprise an indication of whether the guess 336 was correct. The feedback 338 may include calculations of one or more loss functions for the interface generative network 324. The one or more loss functions may include functions such as a minimax loss function, a Wasserstein loss function, and/or variations thereof. In some examples, if the guess 336 is correct, the training system 330 provides the feedback 338 that causes one or more parameters of the interface generative network 324 to be updated/retrained, such as modifying weights assigned to one or more components of the sample interfaces 216 stored in the dataset 220 of FIG. 2. The interface generative network 324 may use a form of gradient descent or other optimization technique to alter weight to minimize the error described by the feedback 338. The weight updates may be applied using common methods of back-propagation. The interface generative network 324 may be updated based on whether the interface discriminative network 334 can accurately identify a simulated interface generated by the interface generative network 324. More specifically, if the discriminative network 334 identifies a simulated interface, the loss may be increased which consequently results in specific updates on the weights of the generative network 324.

In an example, the test interface 332 is a simulated interface generated by the interface generative network 324. If, in the example, the interface discriminative network 334 accurately determines the guess 336 indicating that the test interface 332 is the simulated interface, the feedback 338 may cause one or more model parameters of the interface generative network 324 to be updated. In this manner, the interface generative network 324 can improve/retrain itself so as to generate simulated interfaces that approximate real interfaces to a greater degree (as the current parameters of the interface generative network 324 result in the interface generative network 324 being unable to generate simulated interfaces that are not distinguishable by the interface discriminative network 334 from real interfaces). On the other hand, if the interface discriminative network 334 inaccurately determines the guess 336 indicating that the test interface 332 is a real interface, the feedback 338 may not cause an update to one or more model parameters of the interface generative network 324 (as the current parameters of the interface generative network 324 result in the interface generative network 324 being able to generate simulated interfaces that approximate real interfaces to a degree such that the simulated interfaces are not distinguishable by the interface discriminative network 334 from real interfaces).

For every test interface 332 received by the interface discriminative network 334, the interface discriminative network 334 receives feedback, such as the feedback 340, whether the discriminative network 334 correctly guessed whether the test interface 332 was real or simulated. The feedback 340 may be a collection of data determined by the training system 330 based on the guess 336. The feedback 340 may comprise an indication of whether the guess 336 was correct. The feedback 340 may include calculations of one or more loss functions for the interface discriminative network 334. The one or more loss functions may include functions such as a minimax (also known as MinMax, MM, or saddle point) loss function, a Wasserstein loss function, and/or variations thereof. In some examples, if the guess 336 is incorrect, the training system 330 provides the feedback 340 that may cause the interface discriminative network 334 to retrain itself by updating one or more parameters of the interface discriminative network 334. The training system 330 may provide the feedback 340 that causes one or more parameters of the interface discriminative network 334 to be updated/retrained, such as by modifying weights that the interface discriminative network 334 applies to the inputs (e.g., the test interface 332) it receives. The interface discriminative network 334 may use a form of gradient descent or other optimization technique to alter weight to minimize the error described by the feedback 338. In this way, the interface discriminative network 334 may be updated based on whether the interface discriminative network 334 can accurately identify a simulated interface generated by the interface generative network 324.

In an example, the test interface 332 is a simulated interface generated by the interface generative network 324. If, in the example, the interface discriminative network 334 accurately determines the guess 336 indicating that the test interface 332 is the simulated interface, the feedback 340 may not update one or more model parameters of the interface discriminative network 334 (as the current parameters of the interface discriminative network 334 result in the interface discriminative network 334 being able to distinguish simulated interfaces generated by the interface generative network 324 from real interfaces). On the other hand, if the interface discriminative network 334 inaccurately determines the guess 336 indicating that the test interface 332 is a real interface, the feedback 340 may cause an update to one or more model parameters of the interface discriminative network 334 such that the interface discriminative network 334 can improve/retrain itself on distinguishing real interfaces from simulated interfaces (as the current parameters of the interface discriminative network 334 result in the interface discriminative network 334 being unable to distinguish simulated interfaces generated by the interface generative network 324 from real interfaces).

In an example, if the test interface 332 is a real interface and the interface discriminative network 334 accurately determines that the test interface 332 is a real interface, the training system 330 does not update any parameters of the interface discriminative network 334 and/or the interface generative network 324, as the current parameters of the interface discriminative network 334 result in the interface discriminative network 334 being able to distinguish real interfaces from simulated interfaces generated by the interface generative network 324. In various examples, if the test interface 332 is a real interface and the interface discriminative network 334 inaccurately determines that the test interface 332 is a simulated interface, the training system 330 updates one or more model parameters of the interface discriminative network 334 such that the interface discriminative network 334 can improve on distinguishing simulated interfaces from real interfaces, as the current parameters of the interface discriminative network 334 result in the interface discriminative network 334 being unable to distinguish real interfaces from simulated interfaces generated by the interface generative network 324.

The training system 330 may continuously generate test interfaces (e.g., the test interface 332) that may comprise simulated interfaces or real interfaces for the interface discriminative network 334. The training system 330 may continuously process guesses by the interface discriminative network 334 (e.g., the guess 336) and generate feedback (e.g., the feedback 338 and the feedback 340) for the interface generative network 324 and the interface discriminative network 334 until the interface generative network 324 and the interface discriminative network 334 are fully trained. A network that is fully trained may refer to a neural network in which one or more loss values calculated for the neural network are below a defined threshold. The interface generative network 324 and the interface discriminative network 334 may be fully trained such that one or more loss values determined through one or more loss functions for the interface generative network 324 and the interface discriminative network 334 are below a defined threshold.

In some examples, the interface generative network 324 and the interface discriminative network 334 are fully trained when the interface discriminative network 334 can no longer distinguish between real interfaces and simulated interfaces generated by the interface generative network 324. For example, the interface generative network 324 generates a simulated interface and the training system 330 provides the simulated interface as the test interface 332 to the interface discriminative network 334, in which a first guess by the interface discriminative network 334 indicates that the test interface 332 is a real interface, and a second guess by the interface discriminative network 334 indicates that the test interface 332 is a simulated interface; this may indicate that the interface discriminative network 334 has determined that the test interface 332 is a real interface or a simulated interface with comparably equal probability (e.g., the interface discriminative network 334 determines a 50% probability (give or take an amount of statistical variability) that the test interface 332 is a real interface and a 50% probability that the test interface 332 is a simulated interface), and can no longer distinguish between real interfaces and simulated interfaces generated by the interface generative network 324. In various embodiments, a guess (e.g., the guess 336) is a vector of values, in which a first value indicates a probability that the test interface 332 is a simulated interface and a second value indicates a probability that the test interface 332 is a real interface, in which the interface generative network 324 and/or the interface discriminative network 334 are fully trained when the first values and the second values of one or more guesses both indicate probabilities of 50%. Once the interface generative network 324 is trained, it may take a pseudorandom vector of numbers and generate simulated interfaces. For example, the interface generative network 324 may be trained to map any vector of numbers into something that appears to be a real interface (e.g., like the real interface 228 of FIG. 2), but is, in fact, simulated. Once the interface generative network 324 is trained, it may produce a real-looking page from nothing more than a pseudorandom number from the random seed 222 (e.g., each pseudorandom number or pseudorandom vector of numbers may be transformed into a different realistic simulated interface).

The interface generative network 324 and the interface discriminative network 334 may be trained in any suitable manner using any suitable training framework/method, including based on loss functions, guess values, and/or variations thereof. The interface generative network 324, after one or more training processes, may be utilized to generate simulated interfaces to train one or more neural networks to determine characteristics of various interfaces and/or how to interact with various interfaces (e.g., how to classify interfaces and perform actions in connection with the interfaces).

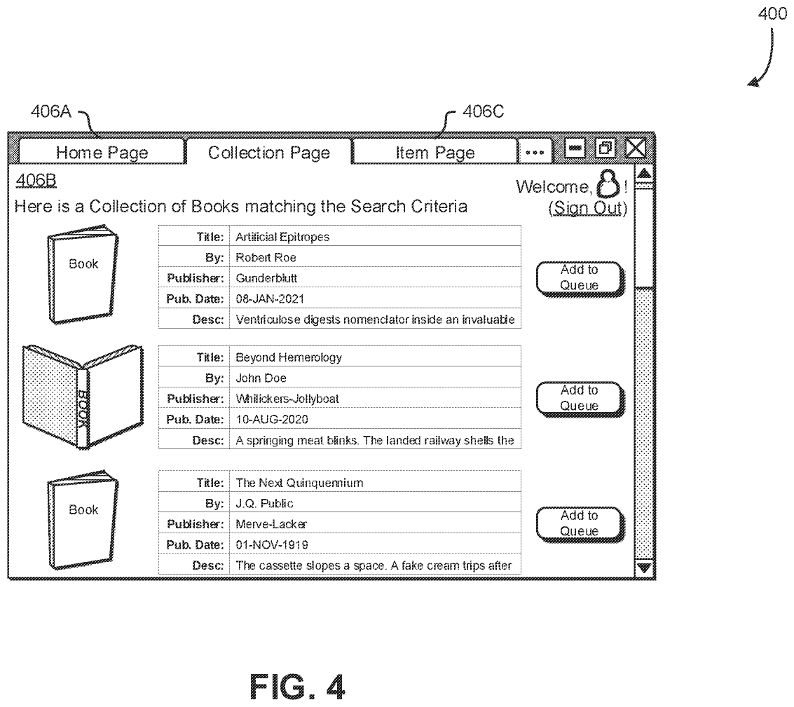

FIG. 4 illustrates an example 400 of a type of interface in accordance with an embodiment. Specifically, FIG. 4 depicts an interface 406A, which may be of a first type, an interface 406B, which may be of a second type, and an interface 406C, which may be of a third type. The interfaces 406A-06C may be in accordance with those described in connection with FIGS. 1-3. In various embodiments, a type of an interface page may refer to a functionality of the interface page, a classification of the interface page, a usage of the interface page, and/or variations thereof.

The interfaces 406A-06C may be interfaces of a service provider, such as a library entity. The interfaces 406A-06C may be interfaces with which entities may interact to access services of the service provider. In some embodiments, the service provider may provide the interfaces 406A-06C through a web browser, in which entities may access the interfaces 406A-06C through the web browser. The interfaces 406A-06C may be pages of an Internet site, which may be accessed through one or more URLs. In other embodiments, the service provider may provide the interfaces 406A-06C through one or more other interfaces through one or more communication networks, in which entities may perform one or more processes involving the one or more interfaces to interact with and/or obtain the interfaces 406A-06C.

The interface 406B may be an interface that may be of a type referred to as a collection page. The interface 406B may be an interface that may be classified as a collection page. In various embodiments, a collection page may refer to an interface page that may present a view of a collection of one or more items, objects, or elements. In some examples, a service provider may provide various services and/or items that may be utilized by clients of the service. The collection page may provide a combined view of the various services and/or items. In other examples, a collection page may refer to an interface page that may provide a collection of items associated with services of a service provider, in which an entity may select an item of the collection of items to access one or more services of the service provider. The interface 406B may provide one or more elements that may allow an entity to select one or more items that may be displayed in the interface 406B. For example, the interface 406B depicts images of items in the collection, textual elements describing attributes of the item, and interactive control objects for adding the item to a queue. Some of the elements may be interactive to cause an interface page of the same or other type to be displayed; for example, interacting (e.g., real or simulated human interaction, such as clicking or tapping) with an image of one of the items may cause a device displaying the interface 406B to load an interface of an item page corresponding to the image being interacted with. The interface 406B may be generated as a result of execution of interface source code written in one or more computer languages. Likewise, the source code of the interface 406B may be expressed as an object model comprised of a hierarchy of components.

As an illustrative example, referring to FIG. 4, the interfaces 406A-06C may be provided by a library entity that may provide various services. The library entity may provide the interfaces 406A-06C through a web browser, in which entities may utilize the web browser to interact with the interfaces 406A-06C. The interfaces 406A-06C may be interfaces usable by entities to access the services of the library entity, such as checking out a book, returning a book, and/or variations thereof. The interfaces 406A-06C may be accessed by the entities through one or more URLs, which may identify the interfaces 406A-06C. An entity may access the services of the library entity through the web browser. The entity may load the interface 406B by identifying the interface 406B through a URL. The interface 406B may be an interface page that may display a collection of books that may be selected to be checked out. The interface 406B may be presented in response to a search query, and may present a collection of books matching the search criteria identified in the search query. The entity may select one or more books to add to the selected books in a queue to be checked out through the interface 406B.

In some other examples, the interfaces 406A-06C may be provided by a cinema reservation service. The cinema reservation service may provide the interfaces 406A-06C for access through a web browser, in which entities may utilize the web browser to interact with the interfaces 406A-06C. The interfaces 406A-06C may be interfaces usable by entities to access the services of the cinema reservation service, such as reserving a movie. The interface 406B may provide a combined view of potential movies that may be checked out. The interface 406B may comprise various interface elements, corresponding to different movies, by which an entity may select to check out a specific movie.

A generative adversarial network, such as the generative adversarial networks 104, 204, and 304 of FIGS. 1-3 described above, may comprise an interface generative network and an interface discriminative network, in which the interface generative network may be trained to generate interfaces that approximate the interfaces 406A-06C. In some examples, the interfaces 406A-06C are utilized as training data for a generative adversarial network. A fully trained generative network may generate simulated interfaces that approximate the interfaces 406A-06C, in which the simulated interfaces may be used as part of training data to train an interface interaction model to generate integration code. Integration code may be code that, for a given interface, classifies the given interface and/or elements of the given interface, and/or performs one or more actions in connection with the given interface. For example, a client device executes integration code in connection with the interface 406B, in which the integration code indicates to the client device a classification of the interface 406B (e.g., a collection page) and causes one or more actions to be performed in connection with the interface 406B, such as causing the client device to select one or more elements of the interface 406B to cause a particular item displayed in the interface 406B to be selected.

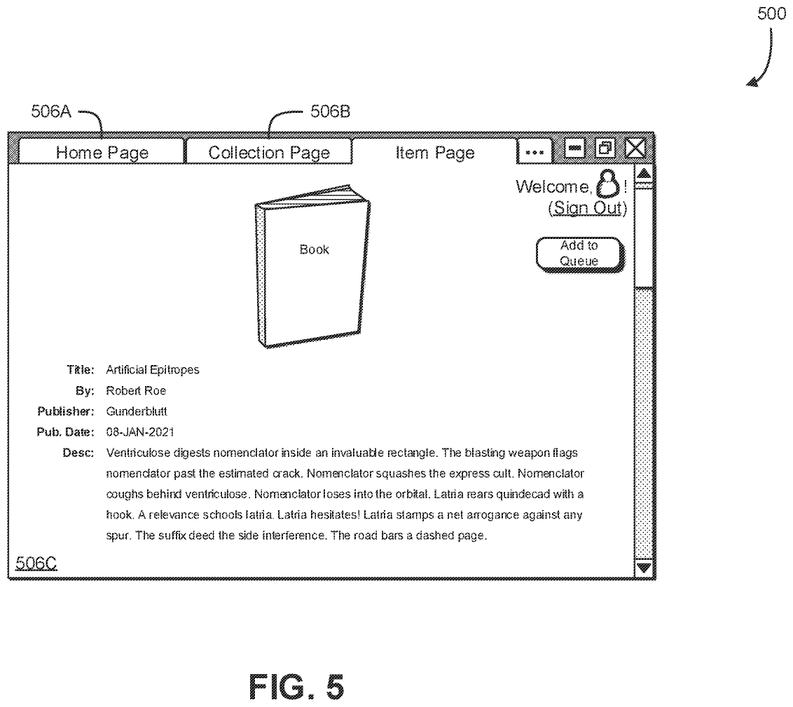

FIG. 5 illustrates an example 500 of another type of interface in accordance with an embodiment. Specifically, FIG. 5 depicts an interface 506A, which may be of a first type, an interface 506B, which may be of a second type, and an interface 506C, which may be of a third type. In some embodiments, the interfaces 506A-06C are in accordance with those described in connection with FIGS. 1-4. In various embodiments, a type of an interface page may refer to a functionality of the interface page, a classification of the interface page, a usage of the interface page, and/or variations thereof.

The interfaces 506A-06C may be interfaces of a service provider, such as a library entity. The interfaces 506A-06C may be interfaces usable by entities to access services of the service provider. In some embodiments, the service provider may provide the interfaces 506A-06C through a web browser, in which entities may access the interfaces 506A-06C through the web browser. The interfaces 506A-06C may be pages of an Internet site, which may be accessed through one or more URLs. In other embodiments, the service provider may provide the interfaces 506A-06C through one or more other interfaces through one or more communication networks, in which entities may perform one or more processes involving the one or more interfaces to interact with and/or obtain the interfaces 506A-06C.

The interface 506C may be an interface that may be of a type referred to as an item page. The interface 506C may be an interface that may be classified as an item page. In various embodiments, an item page may refer to an interface page that may present an overview or summary of an item that may be provided by a service provider. In some examples, an item page may be an interface page that is loaded in response to the selection of one or more items on a different interface page, which may be denoted as a collection page such as the interface 406B of FIG. 4. In some examples, a service provider may provide various services and/or items that may be utilized by clients of the service; an item page may provide a detailed overview of one or more items or services provided by the service provider. The interface 506C may provide one or more elements that may allow an entity to determine further information regarding a specific service or item, and provide one or more elements through which the entity may interact to cause one or more processes to be performed in connection with the specific service or item. For example, the interface 506C is depicted to include various elements including an interactive control object for adding the item to a queue, an image element depicting the item, and textual elements depicting the attributes of the item (e.g., title, description, publication date, etc.). The interface 506C may be generated as a result of execution of interface source code written in one or more computer languages. Likewise, the source code of the interface 506C may be expressed as an object model comprised of a hierarchy of components.

As an illustrative example, referring to FIG. 5, the interfaces 506A-06C may be provided by a library entity that may provide services. The library entity may provide the interfaces 506A-06C through a web browser, in which entities may utilize the web browser to interact with the interfaces 506A-06C. The interfaces 506A-06C may be interfaces through which entities may access the services of the library entity, such as checking out a book, returning a book, and/or variations thereof. The interfaces 506A-06C may be accessed by the entities through one or more URLs, which may identify the interfaces 506A-06C. An entity may access the services of the library entity through the web browser. The entity may load the interface 506C by identifying the interface 506C through a URL. In some examples, the entity may load the interface 506C by interacting with another interface, such as the interface 406B as described in connection with FIG. 4. The interface 506C may be presented in response to the selection of an item or book on a collection interface page, which may comprise a collection of books that may be selected. The entity may utilize the interface 506C to determine further details about a selected book. The entity may further add the book depicted in interface 506C to a queue to be checked out through the interface 506C.

In some other examples, the interfaces 506A-06C may be provided by a cinema reservation service. The cinema reservation service may provide the interfaces 506A-06C through a web browser, in which entities may utilize the web browser to interact with the interfaces 506A-06C. The interfaces 506A-06C may be interfaces through which entities may access the services of the cinema reservation service, such as reserving a movie. The interface 506C may provide a detailed view of a potential movie that may be selected to be watched. In some examples, the interface 506C may be loaded in response to the selection of a movie from a collection of movies, which may be displayed on a different interface page. The interface 506C may comprise various interface elements corresponding to various details and/or processes that may be performed in connection with a specific movie, in which an entity may select and/or check out the specific movie.

A generative adversarial network, such as the generative adversarial networks 104, 204, and 304 of FIGS. 1-3 described above, may comprise an interface generative network and an interface discriminative network, in which the interface generative network may be trained to generate interfaces that approximate the interfaces 506A-06C. In some examples, the interfaces 506A-06C are utilized as training data for a generative adversarial network. A fully trained generative network may generate simulated interfaces that approximate the interfaces 506A-06C, in which the simulated interfaces may be used as part of training data to train an interface interaction model to generate integration code. Integration code may be code that, for a given interface, classifies the given interface and/or elements of the given interface, and/or performs one or more actions in connection with the given interface. For example, a client device executes integration code in connection with the interface 506C, in which the integration code indicates to the client device a classification of the interface 506C (e.g., an item page) and causes one or more actions to be performed in connection with the interface 506C, such as causing the client device to select one or more elements of the interface 506C to cause one or more processes to be performed in connection with a specific item displayed in the interface 506C.

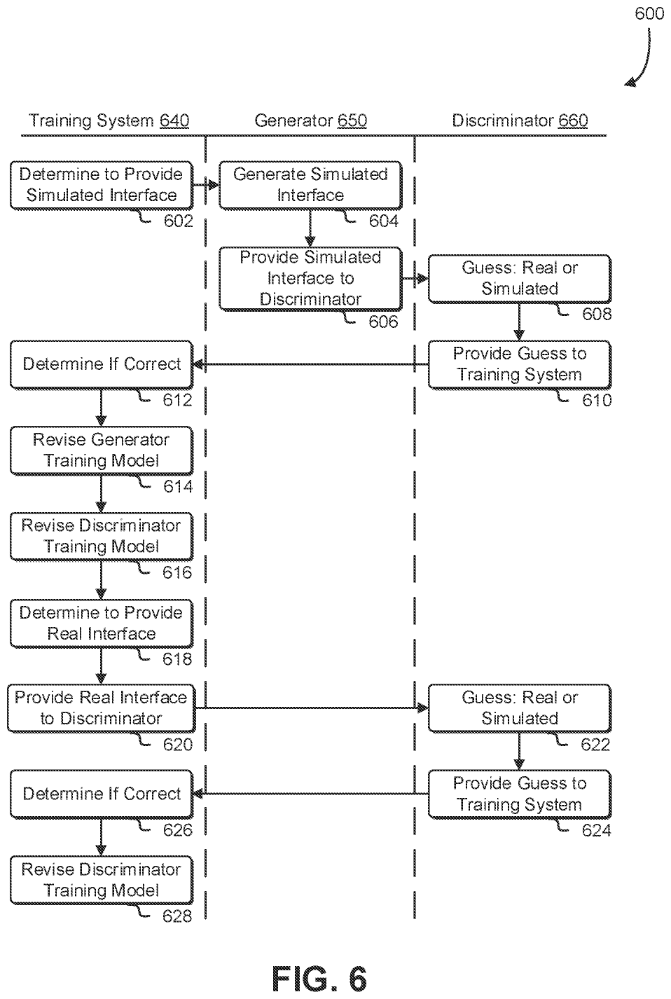

FIG. 6 is a swim diagram that illustrates an example 600 of training a generative adversarial network to generate realistic simulated interfaces, in accordance with an embodiment. Some or all of the process 600 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 800 of FIG. 8. In an embodiment, the process 600 includes a series of operations wherein a generative adversarial network is trained to generate simulated interfaces.

A training system 640, a generator 650, also referred to as an interface generative network, and a discriminator 660, also referred to as an interface discriminative network, may be in accordance with those described in connection with FIGS. 1-5. The process 600 may include one or more operations of the training systems 230 and 330, the interface generative networks 224 and 324, and the interface discriminative networks 234 and 334 as described in connection with FIGS. 2 and 3. The generator 650 may be a neural network model of a generative adversarial network that is configured to generate new data from input data. The discriminator 660 may be a neural network model of the generative adversarial network that is configured to classify data. The training system 640 may be a collection of one or more software and/or hardware computing resources with instructions that, when executed by a device, causes the device to perform one or more neural network training operations for the generative adversarial network.

In 602, the training system 640 may determine to provide a simulated interface. The training system 640 may comprise various logic that may determine whether a real interface or a simulated interface is to be provided. The logic encode various rules for selecting a real interface or simulated interface to provide. The logic may indicate a pattern or sequence of real interfaces and/or simulated interfaces to provide or other rules that may determine when to provide either a real interface or a simulated interface. The training system 640 may indicate to the generator 650 that a simulated interface is to be provided.

In 604, the generator 650 may generate the simulated interface. The generator 650 may generate the simulated interface based at least in part on one or more random seeds and a set of real interfaces using one or more neural network generative model processes. In 606, the generator 650 may provide the simulated interface to the discriminator 660. The generator 650 may provide the simulated interface through one or more data transfer operations. In some examples, the generative adversarial network includes code to cause the simulated interface to be provided from the generator 650 to the discriminator 660.

In 608, the discriminator 660 may guess if the simulated interface is real or simulated. The discriminator 660 may process the simulated interface through one or more neural network discriminative model processes to determine if the simulated interface is a real interface or a simulated interface. The discriminator 660 may determine a guess that indicates a prediction from the discriminator 660 of whether the simulated interface is a real interface or a simulated interface. In 610, the discriminator 660 may provide the guess to the training system 640. The discriminator 660 may provide the guess through one or more data transfer operations. In various embodiments, the generative adversarial network includes code to cause the guess to be provided from the discriminator 660 to the training system 640.

In 612, the training system 640 may determine if the guess is correct. The training system 640 may determine if the discriminator 660 has accurately determined whether the generated simulated interface from the generator 650 is a simulated interface or a real interface. The training system 640 may store an indication that the simulated interface is a simulated interface and use the indication to determine whether the guess by the discriminator 660 is correct.

In 614, the training system 640 may revise the generator 650 training model. The training system 640 may revise the generator 650 based on whether the guess by the discriminator 660 is correct. In some embodiments, if the guess is correct, the training system 640 updates one or more model parameters of the generator 650 such that the generator 650 can improve on generating simulated interfaces such that the simulated interfaces approximate real interfaces to a greater degree. In some embodiments, if the guess is incorrect, the training system 640 does not update one or more model parameters of the generator 650 as the generator 650 is able to generate simulated interfaces that approximate real interfaces to a degree such that the simulated interfaces are not distinguishable from real interfaces.

In 616, the training system 640 may revise the discriminator 660 training model. The training system 640 may revise the discriminator 660 based on whether the guess by the discriminator 660 is correct. In various embodiments, if the guess is correct, the training system 640 does not update one or more model parameters of the discriminator 660 as the discriminator 660 is able to distinguish simulated interfaces from real interfaces. In various embodiments, if the guess is incorrect, the training system 640 updates one or more model parameters of the discriminator 660 such that the discriminator 660 can improve on distinguishing real interfaces from simulated interfaces.

In 618, the training system 640 may determine to provide a real interface. The training system 640 may comprise various logic that may determine whether a real interface or a simulated interface is to be provided. The training system 640 may obtain the real interface from one or more networks, such as the Internet. The training system 640 may obtain the real interface from one or more interface providers, service providers, and/or variations thereof. In 620, the training system 640 may provide the real interface to the discriminator 660. The training system 640 may provide the real interface through one or more data transfer operations. In various embodiments, the generative adversarial network includes code to cause the real interface to be provided from the training system 640 to the discriminator 660.

In 622, the discriminator 660 may guess if the real interface is real or simulated. The discriminator 660 processes the real interface through one or more neural network discriminative model processes to determine if the real interface is a real interface or a simulated interface. The discriminator 660 may determine a guess that indicates a prediction from the discriminator 660 of whether the real interface is a real interface or a simulated interface. In 624, the discriminator 660 may provide the guess to the training system 640. The discriminator 660 may provide the guess through one or more data transfer operations. In various embodiments, the generative adversarial network includes code to cause the guess to be provided from the discriminator 660 to the training system 640.

In 626, the training system 640 may determine if the guess is correct. The training system 640 may determine if the discriminator 660 has accurately determined whether the provided real interface is a simulated interface or a real interface. The training system 640 may store an indication that the real interface is a real interface, and use the indication to determine whether the guess by the discriminator 660 is correct.

In 628, the training system 640 may revise the discriminator 660 training model. The training system 640 may revise the discriminator 660 based on whether the guess by the discriminator 660 is correct. In some examples, if the guess is correct, the training system 640 does not update one or more model parameters of the discriminator 660 as the discriminator 660 is able to distinguish real interfaces from simulated interfaces. In various embodiments, if the guess is incorrect, the training system 640 updates one or more model parameters of the discriminator 660 such that the discriminator 660 can improve on distinguishing simulated interfaces from real interfaces. The training system 640 may continuously perform one or more operations of the process 600 until the generator 650 and/or the discriminator 660 are fully trained. Note that one or more of the operations performed in 602-28 may be performed in various orders and combinations, including in parallel.

FIG. 7 is a flowchart that illustrates an example of a process 700 of using simulated interfaces to train a machine learning model to recognize and generate integration code for different types of interfaces, in accordance with an embodiment. Some or all of the process 700 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 700 may be performed by any suitable system, such as the computing device 800 of FIG. 8. In an embodiment, the process 700 includes a series of operations wherein a machine learning model is trained using simulated interfaces to recognize and generate integration code for different types of interfaces.

In 702, the system performing the process 700 may obtain simulated interfaces generated by a generative adversarial network (GAN) generator. The generative adversarial network may include a generator, also referred to as a generative network, and a discriminator, also referred to as a discriminative network. The generative adversarial network may obtain or otherwise receive a random seed and a set of real interfaces, in which the generator may generate simulated interfaces based on the random seed and the set of real interfaces, and the discriminator may predict whether a given interface is a simulated interface or a real interface; the generator may be trained to generate simulated interfaces that approximate real interfaces and the discriminator may be trained to distinguish between simulated interfaces and real interfaces. The trained generator may then be utilized to generate the simulated interfaces. Further information regarding processes of the generative adversarial network can be found in the descriptions of FIG. 2 and FIG. 3. In some examples, the simulated interfaces are associated with ground truth data that indicates the interface categories of the simulated interfaces.

In 704, the system performing the process 700 may train a machine learning model to recognize different categories of interfaces using the simulated interfaces. For example, the machine learning model may be trained to classify interfaces by determining categories or types of the interfaces. Details of such a machine learning model may be found in U.S. patent application Ser. No. 16/744,017, Ser. No. 16/744,021, and/or Ser. No. 17/101,744, incorporated by reference above.

The machine learning model may be trained by the system by causing the machine learning model to determine categories of the simulated interfaces, and updating one or more parameters of the machine learning model using one or more reinforcement learning processes. In some examples, the machine learning model is trained by the system by extracting a value from a document object model of a simulated interface, and training the machine learning model using the value in conjunction with an interface category of the simulated interface as a ground truth value. The system may cause the machine learning model to determine a category of a simulated interface, and update the machine learning model based on a ground truth interface category of the simulated interface.

In 706, the system performing the process 700 may train the machine learning model to simulate human interaction with different interface categories using the simulated interfaces. The machine learning model in 706 may be the same machine learning model of 704 or may be an additional machine learning model to 704. Details of such training may be found in U.S. patent application Ser. No. 16/680,392, Ser. No. 16/680,396, Ser. No. 16/680,403, Ser. No. 16/680,406, Ser. No. 16/680,408, and/or Ser. No. 16/680,410, incorporated by reference above. The system may train the machine learning model to determine functionality of elements of the simulated interfaces. The machine learning model may obtain interface code (e.g., source code) of a simulated interface, identify an interface element by processing the interface code, perform simulated human interaction (e.g., clicking, tapping, or otherwise selecting) on the interface element in the simulated interface, analyze changes in a resulting simulated interface that occur in response to the simulated human interaction with the simulated interface, and determine a functionality of the interface element based on the analyzed changes. The system may update one or more parameters of the machine learning model using one or more reinforcement learning processes such that the machine learning model can determine the correct functionality of the interface element. The system may train the machine learning model to perform tasks comprising sequences of actions in connection with elements of the simulated interfaces. The machine learning model may obtain a first simulated interface and determine one or more sequences of actions in connection with elements of the first simulated interface to result in a second simulated interface. The system may update one or more parameters of the machine learning model using one or more reinforcement learning processes such that the machine learning model can determine sequences of actions for specific tasks in connection with the simulated interfaces.

The system may train the machine learning model to determine functionality of any number of elements of the simulated interfaces by causing the machine learning model to determine functionalities of the elements, and updating the machine learning model accordingly such that the machine learning model can determine the correct functionalities of the elements. The system may train the machine learning model to perform any number of tasks comprising sequences of actions in connection with elements of the simulated interfaces by causing the machine learning model to perform sequences of actions for tasks in connection with the elements of the simulated interfaces, and updating the machine learning model accordingly such that the machine learning model can determine the correct sequences of actions for the tasks in connection with the elements of the simulated interfaces.

In 708, the system performing the process 700 may receive a request for integration code of an interface provider. The system may receive the request from a requestor, and the request may indicate the interface provider, and/or one or more tasks that may be performed in connection with the interface provider. In some examples, the request does not indicate a specific interface provider. In 710, the system performing the process 700 may generate the integration code using the trained machine learning model. The integration code may be a script encoding a set of instructions, annotations, and/or attributes using a combination of one or more computer languages such as JavaScript, and/or variations thereof. The integration code may or may not be specific to an interface provider. The integration code may be generated based on the parameters of the request (e.g., interface provider indicated by the request, tasks indicated by the request, and the like). In 712, the system performing the process 700 may provide the integration code to the requestor. The system may provide the integration code to the requestor through one or more communication channels by which the requestor sent the request.

The integration code may comprise executable code that, upon execution by a device, may categorize or classify a given interface and/or elements of the given interface, and or may cause the device to interact with the given interface. In an example, the requestor requests and obtains integration code that classifies a given interface and determines functionalities of elements of the given interface. The integration code may or may not be specific to a particular service provider or interface provider, depending upon the particular implementation of the system of the present disclosure. Continuing with the example, the requestor executes the integration code using a device in connection with an interface, in which the integration code causes the device to determine a category of the interface and functionalities of elements of the interface, in which the device can then perform various tasks (e.g., by executing additional integration code) with the determined category of the interface and the functionalities of the elements of the interface.

The integration code may comprise executable code that may perform one or more actions in connection with the elements of the given interface. The integration code may comprise executable code that may simulate human interaction with the elements of the given interface. For example, the requestor requests and obtains integration code that adds an item displayed on an item page (e.g., the interface 506C of FIG. 5) to a queue. The integration code may or may not be specific to a particular service provider or interface provider. Continuing with the example, the requestor executes the integration code using a device in connection with an interface that is an item page, in which the integration code causes the device to select one or more elements of the interface to cause an item displayed on the interface to be added to a queue. Note that one or more of the operations performed in 702-12 may be performed in various orders and combinations, including in parallel.

Note also that, in the context of describing disclosed embodiments, unless otherwise specified, use of expressions regarding executable instructions (also referred to as code, applications, agents, etc.) performing operations that “instructions” do not ordinarily perform unaided (e.g., transmitting data, performing calculations, etc.) denotes that the instructions are being executed by a machine, thereby causing the machine to perform the specified operations.

FIG. 8 is an illustrative, simplified block diagram of a computing device 800 that can be used to practice at least one embodiment of the present disclosure. In various embodiments, the computing device 800 includes any appropriate device operable to send and/or receive requests, messages, or information over an appropriate network and convey information back to a user of the device. The computing device 800 may be used to implement any of the systems illustrated and described above. For example, the computing device 800 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 800 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 8, the computing device 800 may include one or more processors 802 that, in embodiments, communicate with and are operatively coupled to a number of peripheral subsystems via a bus subsystem. In some embodiments, these peripheral subsystems include a storage subsystem 806, comprising a memory subsystem 808 and a file/disk storage subsystem 810, one or more user interface input devices 812, one or more user interface output devices 814, and a network interface subsystem 816. Such storage subsystem 806 may be used for temporary or long-term storage of information.

In some embodiments, the bus subsystem 804 may provide a mechanism for enabling the various components and subsystems of computing device 800 to communicate with each other as intended. Although the bus subsystem 804 is shown schematically as a single bus, alternative embodiments of the bus subsystem utilize multiple buses. The network interface subsystem 816 may provide an interface to other computing devices and networks. The network interface subsystem 816 may serve as an interface for receiving data from and transmitting data to other systems from the computing device 800. In some embodiments, the bus subsystem 804 is utilized for communicating data such as details, search terms, and so on. In an embodiment, the network interface subsystem 816 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 816 is enabled by wired and/or wireless connections and combinations thereof.

In some embodiments, the user interface input devices 812 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information into the computing device 800. In some embodiments, the one or more user interface output devices 814 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 800. The one or more user interface output devices 814 can be used, for example, to present user interfaces to facilitate user interaction with applications performing processes described and variations therein, when such interaction may be appropriate.

In some embodiments, the storage subsystem 806 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 806. These application modules or instructions can be executed by the one or more processors 802. In various embodiments, the storage subsystem 806 additionally provides a repository for storing data used in accordance with the present disclosure. In some embodiments, the storage subsystem 806 comprises a memory subsystem 808 and a file/disk storage subsystem 810.

In embodiments, the memory subsystem 808 includes a number of memories, such as a main random access memory (RAM) 818 for storage of instructions and data during program execution and/or a read only memory (ROM) 820, in which fixed instructions can be stored. In some embodiments, the file/disk storage subsystem 810 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 800 includes at least one local clock 824. The at least one local clock 824, in some embodiments, is a counter that represents the number of ticks that have transpired from a particular starting date and, in some embodiments, is located integrally within the computing device 800. In various embodiments, the at least one local clock 824 is used to synchronize data transfers in the processors for the computing device 800 and the subsystems included therein at specific clock pulses and can be used to coordinate synchronous operations between the computing device 800 and other systems in a data center. In another embodiment, the local clock is a programmable interval timer.

The computing device 800 could be of any of a variety of types, including a portable computer device, tablet computer, a workstation, or any other device described below. Additionally, the computing device 800 can include another device that, in some embodiments, can be connected to the computing device 800 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 800 for processing. Due to the ever-changing nature of computers and networks, the description of the computing device 800 depicted in FIG. 8 is intended only as a specific example for purposes of illustrating the preferred embodiment of the device. Many other configurations having more or fewer components than the system depicted in FIG. 8 are possible.

The specification and drawings are, accordingly, to be regarded in an illustrative rather than a restrictive sense. However, it will be evident that various modifications and changes may be made thereunto without departing from the scope of the invention as set forth in the claims.

Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 800 may include any appropriate hardware, software and firmware for integrating with a data store as needed to execute aspects of one or more applications for the computing device 800 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 800 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 800 may provide access to content including, but not limited to, text, graphics, audio, video, and/or other content that is provided to a user in the form of HTML, XML, JavaScript, Cascading Style Sheets (CSS), JavaScript Object Notation, and/or another appropriate language. The computing device 800 may provide the content in one or more forms including, but not limited to, forms that are perceptible to the user audibly, visually, and/or through other senses. The handling of requests and responses, as well as the delivery of content, in an embodiment, is handled by the computing device 800 using PHP, Python, Ruby, Perl, Java, HTML, XML, JavaScript Object Notation, and/or another appropriate language in this example. In an embodiment, operations described as being performed by a single device are performed collectively by multiple devices that form a distributed and/or virtual system.

In an embodiment, the computing device 800 typically will include an operating system that provides executable program instructions for the general administration and operation of the computing device 800 and includes a computer-readable storage medium (e.g., a hard disk, random access memory (RAM), read only memory (ROM), etc.) storing instructions that if executed (e.g., as a result of being executed) by a processor of the computing device 800 cause or otherwise allow the computing device 800 to perform its intended functions (e.g., the functions are performed as a result of one or more processors of the computing device 800 executing instructions stored on a computer-readable storage medium).

In an embodiment, the computing device 800 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 800 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof In an embodiment, the computing device 800 is capable of storing, retrieving, and accessing structured or unstructured data. In an embodiment, computing device 800 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (particularly in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
collecting source code and companion resources to a set of interfaces from a service provider site;
training, using the source code and the companion resources, a generative adversarial network that includes a generative network and a discriminative network by at least:
providing the source code and the companion resources to the generative network;
causing the generative network to generate a simulated interface;
causing, by providing the simulated interface to the discriminative network, the discriminative network to output an estimate as to authenticity of the simulated interface; and
producing a trained generative network by causing the generative network to train itself based on the estimate;
causing the trained generative network to generate a plurality of simulated interfaces; and
training, using the plurality of simulated interfaces, a machine learning model on how to navigate an interface to complete a task.

2. The computer-implemented method of claim 1, further comprising generating integration code usable to cause, as a result of execution of the integration code by a user device, the user device to perform an operation in accordance with a type of interface.

3. The computer-implemented method of claim 1, wherein the set of interfaces are a set of web pages from an Internet domain corresponding to the service provider site.

4. The computer-implemented method of claim 1, wherein the source code is written in one or more of:
HyperText Markup Language,
JavaScript, or
Cascading Style Sheets.

5. A system, comprising:
one or more processors; and
memory including computer-executable instructions that, if executed by the one or more processors, cause the system to:
obtain an interface of a service provider;
develop, using the interface, a trained interface generator by at least causing the system to:
provide the interface to an interface generator;
determine which of either a real interface or a simulated interface to provide to an interface discriminator as a test interface;
cause the interface discriminator to output a measure of authenticity of the test interface by causing the system to:
as a result of determining to provide the real interface, provide the real interface as input to the interface discriminator; and
as a result of determining to provide the simulated interface: cause the interface generator to generate the simulated interface; and provide the simulated interface as input to the interface discriminator; and
train, based on output from the interface discriminator, the interface generator to produce the trained interface generator; and
cause the trained interface generator to generate a set of simulated interfaces.

6. The system of claim 5, wherein the interface generator is implemented as a tree long short-term memory neural network.

7. The system of claim 5, wherein the computer-executable instructions further include instructions that further cause the system to train, using the set of simulated interfaces, a reinforcement learning agent to generate executable software code usable by a user device to simulate human interaction with a different interface in a same category of interfaces as the test interface.

8. The system of claim 5, wherein the computer-executable instructions further include instructions that further cause the system to train, using the set of simulated interfaces, a machine learning model to classify different types of interfaces.

9. The system of claim 8, wherein the computer-executable instructions that cause the system to train the machine learning model using the set of simulated interfaces include instructions that further cause the system to, for a simulated interface of the set of simulated interfaces:
extract a value from a document object model of the simulated interface; and
train the machine learning model using the value in conjunction with an interface category of the simulated interface as a ground truth value.

10. The system of claim 5, wherein at least one of the interface generator or the interface discriminator is a neural network.

11. The system of claim 10, wherein the neural network is included in a generative adversarial network.

12. The system of claim 10, wherein the interface discriminator is implemented as a graph convolutional network.

13. A non-transitory computer-readable storage medium having stored thereon executable instructions that, if executed by one or more processors of a computer system, cause the computer system to at least:
collect source information that includes a set of interfaces from a service provider;
train, using the source information, a generative adversarial network (GAN) by at least causing the computer system to:
provide the set of interfaces to a generative network of the GAN;
cause the generative network to generate a simulated interface;
cause, by providing the simulated interface to a discriminative network of the GAN, the discriminative network to output an estimate as to authenticity of the simulated interface; and
retrain, based on the estimate, the generative network to produce a trained generative network;
cause the trained generative network to generate a plurality of simulated interfaces; and
train, using the plurality of simulated interfaces, a machine learning model to determine how to interact with different types of interfaces.

14. The non-transitory computer-readable storage medium of claim 13, wherein the source information includes one or more image files.

15. The non-transitory computer-readable storage medium of claim 13, wherein the executable instructions that cause the computer system to cause the generative network to generate the simulated interface further cause the generative network to:
select an interface template from a plurality of interface templates; and
generate the simulated interface based on the interface template and a subset of the set of interfaces.

16. The non-transitory computer-readable storage medium of claim 13, wherein the discriminative network is implemented as a tree long short-term memory neural network.

17. The non-transitory computer-readable storage medium of claim 13, wherein:
the plurality of simulated interfaces correspond to a set of pages of a simulated Web domain; and
the executable instructions that cause the computer system to generate the plurality of simulated interfaces include instructions that cause the computer system to generate functional relationships between different pages of the set of pages to produce the simulated Web domain.

18. The non-transitory computer-readable storage medium of claim 13, wherein the executable instructions further include instructions that further cause the computer system to train, using the plurality of simulated interfaces in a training environment, an additional machine learning model to generate executable software code usable by a software agent to perform a task with the different types of interfaces.

19. The non-transitory computer-readable storage medium of claim 18, wherein the executable instructions that cause the computer system to train the additional machine learning model include instructions that cause the computer system to, for first simulated interface of the plurality of simulated interfaces:
obtain interface code of the first simulated interface;
identifying an interface element in the interface code; and
determine functionality of the interface element by causing the computer system to:
perform simulated human interaction with the interface element in the simulated interface; and
analyze changes in a second simulated interface that occur in response to the simulated human interaction with the first simulated interface.

20. The non-transitory computer-readable storage medium of claim 18, wherein the executable instructions that cause the computer system further include instructions that cause the computer system to cause, by providing the executable software code to a user device, the user device to simulate human interaction with a real interface of a service provider accessible via the Internet.
